(19) United States
(12) Patent Application Publication
(10) Pub. No.: US 2026/0217125 A1
(43) Pub. Date: Jul. 30, 2026

(54) DUAL POWER SOURCE TEMPERATURE CONTROL SYSTEM

(71) Applicant: Dana Heavy Vehicle Systems Group, LLC, Maumee, OH (US)

(72) Inventor: David BERELS, Plymouth, MI (US)

(21) Appl. No.: 19/041,864

(22) Filed: Jan. 30, 2025

(51) Int. Cl. B60L 1/12; B60H 1/32; H02J 1/08; B60P 3/20

(52) U.S. Cl. CPC B60L 1/12; B60H 1/3222; H02J 1/084; B60L 2210/10; B60L 2210/30; B60P 3/20

(57) ABSTRACT

Methods and systems for operating a portable temperature control system that may be powered via a vehicle’s traction battery or an AC power grid. In one example, a controller determines a presence or absence of AC power being input to the portable temperature controller and activates AC control circuitry if AC power is being input to the portable temperature controller. If AC power is not being input to the portable temperature controller, DC control circuitry may be activated.

### TECHNICAL FIELD

The present disclosure relates to providing electric power to a portable temperature control system. The system and method may be applied to storage units that disconnect or that do not disconnect from an electrified vehicle.

### BACKGROUND AND SUMMARY

Portable storage units allow perishable goods to be moved from a first location to a distant location with minimal change in the state of the perishable goods. One way to maintain the state of perishable goods is to freeze and keep frozen the perishable goods while the perishable goods are being moved from a first location to the distant location. For commercial movement of perishable goods, a diesel truck may provide the motive effort and power to keep the perishable goods frozen during a course of a trip. However, diesel trucks emit carbon dioxide and efforts to reduce carbon dioxide emissions have led some to consider replacing diesel power units with power units that generate no or less carbon dioxide emissions. In some applications where diesel power sources are replaced by other types of power sources, it may be desirable to provide a way of powering a portable storage unit so that perishable goods within the portable storage unit may be transported with less concern of the perishable goods spoiling.

The inventor herein has recognized the abovementioned issues and has developed a portable temperature control system, comprising: a direct current to direct current (DC/DC) electric power converter; an alternating current to direct current (AC/DC) electric power converter; an electric machine mechanically coupled to a refrigerant compressor; and an inverter electrically coupled to the electric machine.

By installing an AC/DC converter and a DC/DC converter to a portable temperature control system, it may be possible to power the portable temperature control system via AC and DC electric power. For example, AC electric power may be supplied to an electric machine that rotates a refrigerant compressor and to an AC/DC converter that provides low voltage electric power to fans of the portable temperature control system when the portable temperature control system is waiting to be moved or unloaded. On the other hand, DC electric power may be supplied to an inverter that supplies AC electric power to the electric machine that rotates a refrigerant compressor and to a DC/DC converter that provides low voltage electric power to the fans of the portable temperature control system when the portable temperature control system being moved or during the course of delivering items stored in the portable temperature control system. Thus, a portable temperature control system may operate via electric power provided by an electric propulsion source or a stationary grid so that an internal combustion engine may not supply power to the portable temperature control system.

The system and method may provide several advantages. Specifically, the system and methods described herein may provide for a portable temperature control system that may operate on vehicle electric power or stationary electric grid power. This allows the portable temperature control system to apply existing infrastructure to operate the portable temperature control system. Further, the portable temperature control system may be powered via high voltage DC electric power supplied via a vehicle propulsion source so that a sole battery may be charged to propel the vehicle and cool items stored in the portable temperature control system. Additionally, an electric machine of the portable temperature control system may be powered via AC or inverter modified DC electric power so that a single machine provides motive effort to rotate a refrigerant compressor of the portable temperature control system.

It may be understood that the summary above is provided to introduce in simplified form a selection of concepts that are further described in the detailed description. It is not meant to identify key features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 shows a schematic representation of an electric vehicle and driveline that may be operated as described herein.

FIG. 2A shows a first example of a portable temperature control system that may be selectively mechanically coupled to the electric vehicle that is shown in FIG. 1.

FIG. 2B shows a second example of a portable temperature control system that is part of the electric vehicle that is shown in FIG. 1.

FIG. 3 shows a schematic diagram for the portable temperature control system that is shown in FIGS. 2A and 2B.

FIG. 4 shows an example method for operating a portable temperature control system.

### DETAILED DESCRIPTION

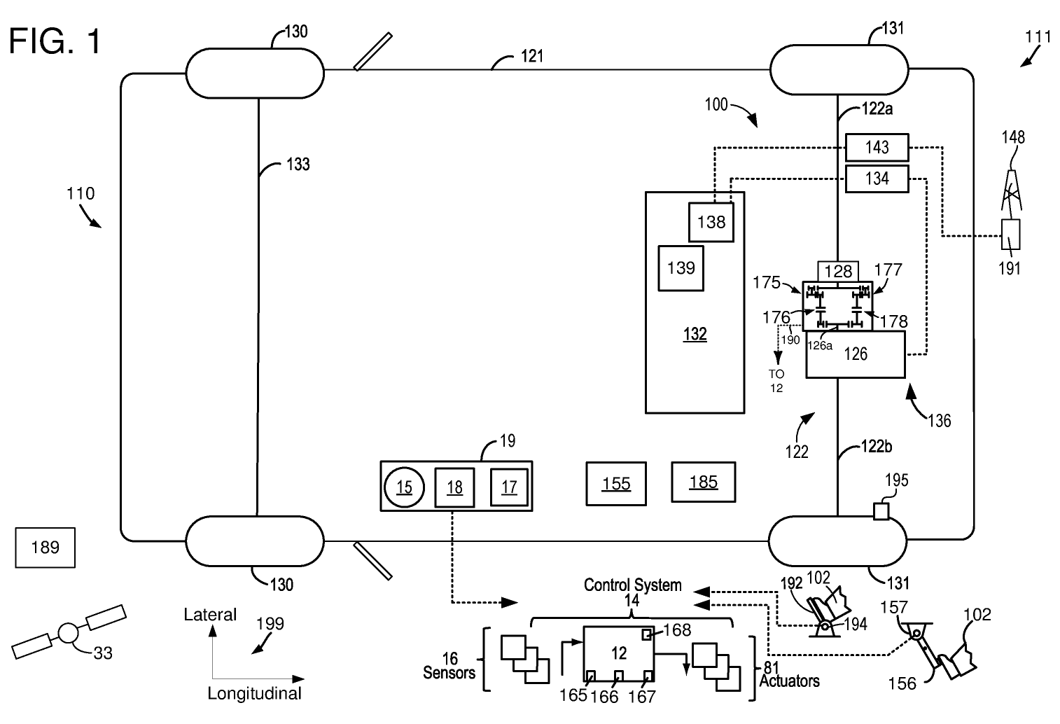

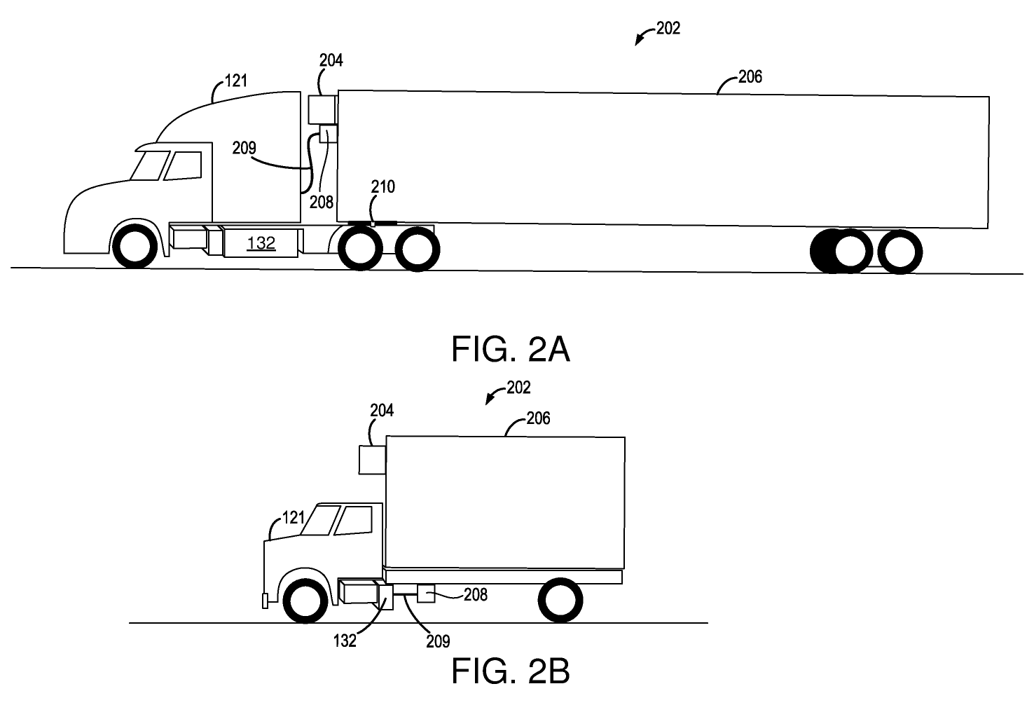

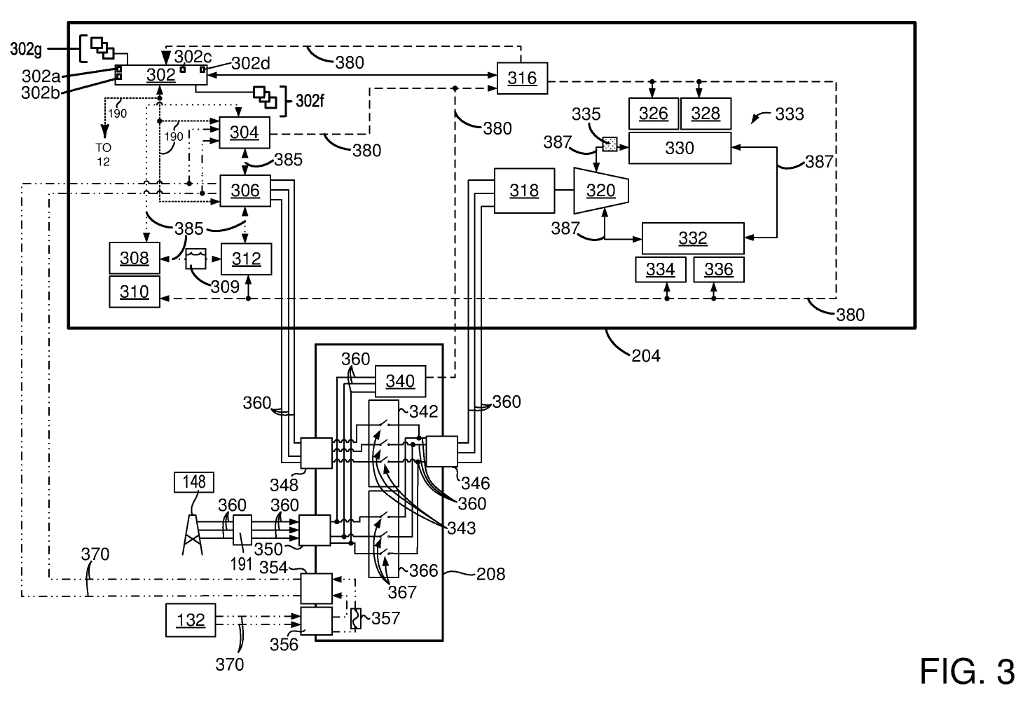

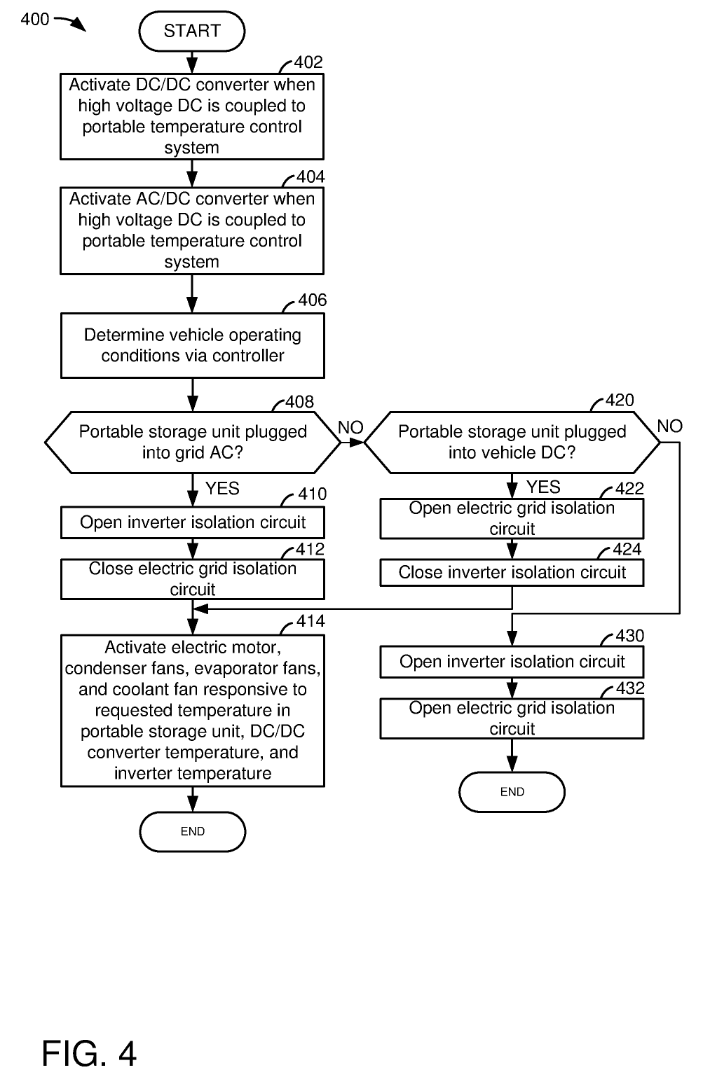

Perishable goods or temperature sensitive goods may be transported by a vehicle that travels on roads. The goods may be temporarily stored in a temperature controlled storage unit. The temperature controlled storage unit may have a capacity to cool or warm goods that are stored in the temperature controlled storage unit. The temperature controlled storage unit may be electrically and mechanically coupled to an electric vehicle of the type that is shown in FIG. 1. Alternatively, the temperature controlled storage unit may be electrically and mechanically coupled to a hybrid vehicle. The temperature controlled storage unit may be selectively coupled to a vehicle as shown in FIG. 2A, or alternatively, it may be part of a vehicle as shown in FIG. 2B. A schematic of a portable temperature control system that may be included with the temperature controlled storage units shown in FIGS. 2A and 2B is shown in FIG. 3. A method for operating a portable temperature control system is shown in FIG. 4.

Referring to FIG. 1, a non-limiting example electric vehicle 121 and its propulsion system 100 are shown. A front portion of vehicle 121 is indicated at 110 and a rear portion of vehicle 121 is indicated at 111. Propulsion system 100 includes an electric machine 126. However, in other examples, vehicle 121 may include two or more electric machines to provide propulsive effort. Electric machine 126 may consume or generate electrical power depending on its operating mode. Throughout the description of FIG. 1, mechanical connections between various components are illustrated as solid lines, whereas electrical connections between various components are illustrated as dashed lines. Longitudinal and lateral directions are indicated at 199.

Propulsion system 100 includes a rear axle 122. In some examples, rear axle 122 may be comprised of two half shafts, for example first half shaft 122a, and second half shaft 122b. Propulsion system 100 further includes rear wheels 131. Rear wheels 131 may be driven via electric machine 126. Vehicle 121 also may include a front axle 133 and front wheels 130.

The rear axle 122 is coupled to electric machine 126. Rear drive unit 136 may transfer power from electric machine 126 to axle 122 resulting in rotation of drive wheels 131. Rear drive unit 136 may include a low gear set 175 and a high gear 177 that are coupled to electric machine 126 via output shaft 126a of rear electric machine 126. Low gear 175 may be engaged via fully closing low gear clutch 176. High gear 178 may be engaged via fully closing high gear clutch 178. High gear clutch 178 and low gear clutch 176 may be opened and closed via commands received by rear drive unit 136 over a controller area network bus (CAN 299). Alternatively, high gear clutch 178 and low gear clutch 176 may be opened and closed via digital outputs or pulse widths provided via vehicle system controller 14. Rear drive unit 136 may include differential 128 so that torque may be provided to axle 122a and to axle 122b. In some examples, an electrically controlled differential clutch (not shown) may be included in rear drive unit 136.

Electric machine 126 may receive electrical power from onboard electrical energy storage device 132 (e.g., a traction battery or a battery that provides power for propulsive effort for vehicle 121). Furthermore, electric machine 126 may provide a generator function to convert the vehicle’s kinetic energy into electrical energy, where the electrical energy may be stored at electric energy storage device 132 for later use by the electric machine 125 and/or electric machine 126. An inverter system controller (ISC) 134 may convert alternating current (AC) generated by rear electric machine 126 to direct current (DC) for storage at the electric energy storage device 132 and vice versa. Electric energy storage device 132 may be a battery, capacitor, inductor, or other electric energy storage device.

Electric energy storage device 132 may be supplied with electric charge from a stationary electric power grid 148 via electric vehicle supply equipment (EVSE 191). Electric charge may be transferred from EVSE 191 to charger 143 (e.g., an alternating current (AC) to direct current (DC) converter). Charger 143 may supply charge to electric energy storage device 132.

Control system 14 may communicate with one or more of electric machine 126, energy storage device 132, and portable temperature control system controller 302 of FIG. 3 via controller area network (CAN 190) and EVSE 191 via cellular phone network 189. Control system 14 may receive sensory feedback information from one or more of electric machine 126, energy storage device 132, charger 143, and portable temperature control system controller 302 of FIG. 3. Further, control system 14 may send control signals to one or more of charger 143, electric machine 126, energy storage device 132, and portable temperature control system controller 302 of FIG. 3 responsive to this sensory feedback. Control system 14 may receive an indication of an operator requested output of the vehicle propulsion system from a human operator 102, or an autonomous controller 155. For example, control system 14 may receive sensory feedback from pedal position sensor 194 which communicates with driver demand pedal 192. Pedal 192 may refer schematically to a driver demand pedal. Similarly, control system 14 may receive an indication of an operator requested vehicle braking via a human operator 102, or an autonomous controller 155. For example, control system 14 may receive sensory feedback from pedal position sensor 157 which communicates with brake pedal 156.

Electric energy storage device 132 includes an electric energy storage device controller 139 and a power distribution module 138. Electric energy storage device controller 139 may provide charge balancing between energy storage element (e.g., battery cells) and communication with other vehicle controllers (e.g., controller 12). Power distribution module 138 controls flow of power into and out of electric energy storage device 132.

One or more wheel speed sensors (WSS) 195 may be coupled to one or more wheels of vehicle propulsion system 100. The wheel speed sensors may detect rotational speed of each wheel. Such an example of a WSS may include a permanent magnet type of sensor.

Controller 12 (e.g., a vehicle system controller) may comprise a portion of a control system 14. In some examples, controller 12 may be a single controller of the vehicle. Control system 14 is shown receiving information from a plurality of sensors 16 (various examples of which are described herein) and sending control signals to a plurality of actuators 81 (various examples of which are described herein). As one example, sensors 16 may include tire pressure sensor(s) (not shown), wheel speed sensor(s) 195, light detecting and ranging (LIDAR) sensors, radio detecting and ranging (RADAR) sensors, cameras, sonic sensors, etc. In some examples, sensors associated with charger 143, electric machine 126, wheel speed sensor 195, etc., may communicate information (e.g., data) to controller 12, regarding various states of electric machine operation. Controller 12 includes non-transitory memory (e.g., read-exclusive memory) 165, random access memory 166, digital inputs/outputs 168, and a microcontroller 167.

Vehicle propulsion system 100 may also include an on-board navigation system 17 (for example, a Global Positioning System) on dashboard 19 that an operator of the vehicle may interact with. The navigation system 17 may include one or more location sensors for assisting in estimating a location (e.g., geographical coordinates) of the vehicle. For example, on-board navigation system 17 may receive signals from GPS satellites 33, and from the signal identify the geographical location of the vehicle. In some examples, the geographical location coordinates may be communicated to controller 12. The navigation system may also break a travel route into an actual total number of segments so that vehicle operation in the segments may be predicted. Navigation system 17 may communicate data from the travel route to controller 12.

Dashboard 19 may further include a display system 18 configured to display information to the vehicle operator. Display system 18 may comprise, as a non-limiting example, a touchscreen, or human machine interface (HMI), display which enables the vehicle operator to view graphical information as well as input commands. In some examples, display system 18 may be connected wirelessly to the internet (not shown) via a controller (e.g. 12). As such, in some examples, the vehicle operator may communicate via display system 18 with an internet site or software application (app).

Dashboard 19 may further include an operator interface 15 via which the vehicle operator may adjust the operating status of the vehicle. Specifically, the operator interface 15 may be configured to initiate and/or cease operation of the vehicle driveline (e.g., electric machine 125 and electric machine 126 may be temporarily deactivated) based on an operator input. Various examples of the operator interface 15 may include interfaces that utilize a physical apparatus, such as a key, that may be inserted into the operator interface 15 to start the electric machine 126 and to turn on the vehicle, or may be removed to shut down the electric machine 126 to turn off the vehicle. Still other examples may additionally or optionally use a start/stop button that is manually pressed by the operator to start or shut down the electric machine 126 to turn the vehicle on or off. In other examples, a remote electric machine start may be initiated remote computing device (not shown), for example a cellular telephone, or smartphone-based system where a user’s cellular telephone sends data to a server and the server communicates with the controller 12 to start the engine.

Vehicle 121 may also include an audio system 185 that may include speakers and horns to provide audible information to vehicle occupants and people that may be outside of the vehicle. The audio system may generate audible messages to indicate vehicle status and to request compliance by humans before actions may be performed.

Referring now to FIG. 2A, a first example of vehicle 121 and temperature controlled storage unit 202 is shown. Temperature controlled storage unit 202 includes a storage enclosure 206, a portable temperature control system 204, and a junction box 208. DC electric power from an electric energy storage device (e.g., 132 of FIG. 1) of vehicle 121 may be electrically coupled to the temperature controlled storage unit 202 via junction box 208 and cable 209. Additionally, AC electric power from a stationary electric power grid may be input to the temperature controlled storage unit 202 via junction box 208.

In this example, temperature controlled storage unit 202 may be selectively mechanically coupled to vehicle 121 via a king pin 210. King pin 210 allows temperature controlled storage unit 202 to pivot about vehicle 121 while vehicle 121 is turning. Thus, temperature controlled storage unit 202 may be totally separated from vehicle 121, or alternatively, mechanically coupled to vehicle 121 via king pin 210.

Referring now to FIG. 2B, a second example of vehicle 121 and temperature controlled storage unit 202 is shown. Similar to FIG. 2A, temperature controlled storage unit 202 includes a storage enclosure 206, a portable temperature control system 204, and a junction box 208. However, in this example storage enclosure 206 does not include a king pin. DC electric power from an electric energy storage device (e.g., 132 of FIG. 1) of vehicle 121 may be electrically coupled to the temperature controlled storage unit 202 via junction box 208 and cable 209. Additionally, AC electric power from a stationary electric power grid may be input to the temperature controlled storage unit 202 via junction box 208.

In this example, temperature controlled storage unit 202 is mechanically fixed to vehicle 121. For example, temperature controlled storage unit 202 may be fastened to vehicle 121 via bolts, screws, or other fasteners.

Referring now to FIG. 3, a schematic of a portable temperature control system 204 and a junction box 208 (e.g., an electric junction box) is shown. In FIG. 3, portable temperature control system 204 is shown separate from junction box 208. However, in some examples, junction box 208 may be incorporated into portable temperature control system 204.

AC electric power from stationary electric power grid 148 may be supplied to EVSE 191 and junction box 208. Three phase electric power conductors 360 as indicated by solid lines distribute three phase AC electric power (e.g., 480 Volt three phase electric power) in and between stationary electric power grid 148, EVSE 191, junction box 208, and portable temperature control system 204 as indicated. AC electric power may enter junction box 208 via connector 350. The AC electric power is distributed from connector 350 to electric grid electric isolation circuit 366 and to alternating current to direct current (AC/DC) electric power converter 340. Electric grid isolation circuit 366 may include three switches as indicated at 367 to selectively electrically isolate AC electric power from portable temperature control system 204. Switches 367 may be realized as hard contacts, relays, field effect transistors, bi-polar transistors, or other solid state devices. AC electric power may exit junction box 208 via connector 346. AC/DC electric power converter 340 may supply low voltage DC electric power (e.g., 48V/24V/12V) to portable temperature control system 204 and low voltage power distribution unit 316. Low voltage power distribution unit 316 may include but is not limited to power control relays or switches, circuit breakers or fuses, and terminals.

AC electric power may also enter junction box 208 via connector 348. The AC electric power that enters junction box 208 at connector 348 is generated via inverter 306. AC electric power is distributed from connector 348 to inverter isolation circuit 342. Inverter isolation circuit 342 may include three switches as indicated at 343 to selectively electrically isolate AC electric power from portable temperature control system 204. Switches 343 may be realized as hard contacts, relays, field effect transistors, bi-polar transistors, or other solid state devices. AC electric power may exit junction box 208 via connector 346. The electric grid isolation circuit 366 and the inverter isolation circuit 342 may reduce a possibility of out of phase three phase circuits from being connected and producing unexpected current flow.

DC electric power may enter junction box 208 via connector 356. The DC electric power that enters junction box 208 at connector 356 may be sourced via electric energy device 132. The DC electric power may pass through fuse 357 to constrain DC current flow through junction box 208. DC electric power may exit junction box 208 via connector 354. High voltage DC electric power (e.g., DC voltage is greater than 60 volts) may be distributed from junction box 208 to portable temperature control system 204 via DC high voltage cables 370, which are shown as double dot dashed lines. High voltage DC electric power may be supplied to inverter 306 and direct current to direct current (DC/DC) electric power converter 304. Inverter 306 may generate high voltage AC electric power (e.g., AC electric power with a voltage that is greater than 200 volts). DC/DC electric power converter 304 may step down high voltage DC electric power to low voltage DC electric power. Low voltage DC electric power may be supplied from DC/DC electric power converter 304 to low voltage power distribution unit 316 via DC low voltage electric power conductors 380, which are indicated as dashed lines.

A liquid coolant 309 may be circulated through inverter 306, DC/DC converter 304 and heat exchanger 308 via coolant pump 312 via conduits 385, which are indicated via dotted lines. Heat energy may be extracted from heat exchanger 308 when coolant fan 310 is activated.

Portable temperature control system 204 includes a refrigerant loop 333 in which refrigerant 335 may be circulated. Refrigerant loop 333 includes a compressor 320 (e.g., a refrigerant compressor) that is mechanically coupled to electric machine 318 (e.g., an induction motor). Electric machine 318 may rotate and drive compressor 320 using AC electric power that may be supplied via inverter 306 or stationary electric power grid 148. In a cooling mode, compressor 320 may compress refrigerant 335 so that refrigerant 335 may flow to evaporator 332 to cool storage enclosure 206 shown in FIG. 2. Via conduits 387, refrigerant 335 may flow from evaporator 332 to condenser 330 where refrigerant 335 may return to a liquid state. In a heating mode, the route of refrigerant may be changed so that evaporator 332 operates to heat storage enclosure 206 shown in FIG. 2.

A first DC condenser fan 326 may blow air over condenser 330 to cool refrigerant flowing there through. Additionally, second DC condenser fan 328 may blow air over condenser 330 to cool refrigerant flowing there through. A first DC evaporator fan 334 may blow air over evaporator 332 to cool air in the storage enclosure 206 shown in FIG. 2. Further, second DC evaporator fan 336 may blow air over evaporator 332 to cool air in the storage enclosure 206 shown in FIG. 2.

Portable temperature control system 204 also includes a portable temperature control system controller 302 that includes a microcontroller 302a, analog inputs/outputs 302b, digital inputs/outputs 303c, and non-transitory memory 302d. Alternatively, portable temperature control system controller 302 may be comprised of logic implemented via relays, solid state logic, programmable logic, or other known logic devices so that microcontroller 302a may not be applied. Controller may receive information from sensors 302f and send output to actuators 302g. Sensors 302f may include but are not constrained to sensors that sense refrigerant temperature and pressure at output of compressor 320, refrigerant temperature and pressure at output of evaporator 332, refrigerant temperature and pressure at output of condenser 330, rotational speed of compressor 320, inverter output voltage, inverter output current, inverter temperature, DC/DC converter temperature, presence of high voltage AC electric power at connector 350, presence of high voltage DC electric power at connector 356, and coolant temperature. Actuators 302g that may be operated via portable temperature control system controller 302 may include but are not constrained to inverter isolation circuit 342, s, inverter 306, first DC condenser fan 326, second DC condenser fan 328, first DC evaporator fan 334, second DC evaporator fan 336, low voltage power distribution unit 316, refrigerant flow control valves, evaporator valves, and coolant fan 310. Portable temperature control system controller 302 may communicate to controller 12 of FIG. 1 via CAN 190.

Thus, the system of FIGS. 1-3 provides for a portable temperature control system, comprising: a direct current to direct current (DC/DC) electric power converter; an alternating current to direct current (AC/DC) electric power converter; an electric machine mechanically coupled to a refrigerant compressor; and an inverter electrically coupled to the electric machine. In a first example, the portable temperature control system further comprises an electric vehicle, the electric vehicle mechanically coupled to the portable temperature control system, the portable temperature control system not including a king pin to couple the portable temperature control system to the electric vehicle. In a second example that may include the first example, the portable temperature control system further comprises an electric vehicle, electric vehicle mechanically coupled to the portable temperature control system, the portable temperature control system including a king pin to couple the portable temperature control system to the electric vehicle. In a third example that may include one or both of the first example and the second example, the portable temperature control system further comprises a power distribution unit, the DC/DC electric power converter and the AC/DC electric power converter electrically coupled to the power distribution unit. In a fourth example that may include one or more of the first through third examples, the portable temperature control system further comprises at least one condenser fan, at least one evaporator fan, the power distribution unit electrically coupled to the at least one condenser fan and the at least one evaporator fan. In a fifth example that may include one or more of the first through fourth examples, the portable temperature control system further comprises a coolant pump and a heat exchanger, the coolant pump and the heat exchanger fluidically coupled to the DC/DC electric power converter. In a sixth example that may include one or more of the first through fifth examples, the portable temperature control system further comprises an inverter, the inverter fluidically coupled to the coolant pump and the heat exchanger. In a seventh example that may include one or more of the first through sixth examples, the portable temperature control system further comprises a heat exchanger fan, the heat exchanger fan electrically coupled to the power distribution unit. In a eighth example that may include one or more of the first through seventh examples, the portable temperature control system further comprises a controller, the controller configured to automatically provide electric power to the electric machine solely via a stationary AC electric power grid when the stationary AC electric power grid is coupled to the portable temperature control system, the controller configured to automatically provide electric power to the electric machine solely via a vehicle’s DC electric power source when the stationary AC electric power grid is decoupled from the portable temperature control system and when the DC electric power source is electrically coupled to the portable temperature control system.

The system of FIGS. 1-3 also provides for a portable temperature control system, comprising: a direct current to direct current (DC/DC) electric power converter; an alternating current to direct current (AC/DC) electric power converter; an electric machine mechanically coupled to a refrigerant compressor; an inverter; an inverter isolation circuit; an electric grid isolation circuit; and a controller configured to automatically close the electric grid isolation circuit to provide electric power to the electric machine via a stationary electric grid and electrically isolate output of the inverter from the electric machine in response to the stationary electric grid being electrically coupled to the portable temperature control system. In a first example, the portable temperature control system includes where the controller is further configured to automatically close the inverter isolation circuit to provide electric power to the electric machine via the inverter and electrically isolate output of the stationary electric grid from the electric machine in response to the stationary electric grid being electrically decoupled from the portable temperature control system and a vehicle DC electric power source being electrically coupled to the portable temperature control system. In a second example that may include the first example, the portable temperature control system includes where the controller includes executable instructions that cause the controller to adjust cooling of the portable temperature control system according to which of a vehicle DC electric power source and the stationary electric grid are providing power to the electric machine. In a third example that may include one or both of the first and second examples, the portable temperature control system includes where the controller includes executable instructions that cause the controller to adjust cooling of the portable temperature control system via adjusting a rotational speed of the electric machine, evaporator fan speed, and condenser fan speed. In a fourth example that may include one or more of the first through third examples, the portable temperature control system includes where the electric grid isolation circuit is comprised of a first group of switches and where the stationary electric grid is comprised of a second group of switches.

Referring now to FIG. 4, a method for operating a portable temperature control system is shown. The method of FIG. 4 may be included in the systems of FIGS. 1-3 as executable instructions stored in non-transitory memory. Alternatively, logic and analog circuitry may be applied to perform the method of FIG. 4. Further still, at least portions of the method of FIG. 4 may be actions performed in the physical world by a controller operating one or more actuators, for example.

At 402, method 400 activates a DC/DC converter (e.g., 304 of FIG. 3) when high voltage DC is applied to a power distribution box of the portable temperature control system (e.g., at connector 356 of FIG. 3). The DC/DC converter is activated so that portable temperature control system controller 302, fans, and other low voltage DC electric power consumers are activated. Method 400 proceeds to 404.

At 404, method 400 activates a AC/DC converter (e.g., 340 of FIG. 3) when high voltage AC is applied to a power distribution box of the portable temperature control system (e.g., at connector 350 of FIG. 3). The AC/DC converter is activated so that portable temperature control system controller 302, fans, and other low voltage DC electric power consumers are activated. Method 400 proceeds to 406.

At 406, method 400 determines operating conditions within the portable temperature control system 204. Method 400 may be determined operating conditions via receiving input from sensors described herein. Operating conditions may include but are not constrained to operating conditions of a DC electric power source that is electrically coupled to the portable temperature controls system (e.g., state of charge, voltage, temperature, etc.), presence or absence of high AC voltage being input to portable temperature control system 204, presence or absence of high DC voltage being input to portable temperature control system 204, refrigerant temperature and pressure at outlet of condenser 330, refrigerant temperature and pressure at outlet of compressor 320, refrigerant temperature and pressure at outlet of evaporator 332, coolant temperature, speed of electric machine 318, and speed of coolant pump 312. Method 400 proceeds to 408.

At 408, method 400 judges whether or not the portable storage unit and the portable storage unit temperature controller are electrically coupled to the stationary electric power grid. In one example, if the portable temperature control system controller 302 detects high voltage AC at connector 350 shown in FIG. 3, the answer is yes and method 400 judges that the portable storage unit and the portable storage unit temperature controller are electrically coupled to the stationary electric power grid. If the portable temperature control system controller 302 does not detect high voltage AC at connector 350 shown in FIG. 3, the answer is no and method 400 judges that the portable storage unit and the portable storage unit temperature controller are not electrically coupled to the stationary electric power grid. If the answer is yes, method 400 proceeds to 410. Otherwise, method 400 proceeds to 420.

At 410, method 400 opens inverter isolation circuit 342 of FIG. 3 (e.g., opens transistors or contacts of inverter isolation circuit 342) so that AC electric power that is generated from DC electric power is isolated from electric machine 318. Thus, electric machine may not run from power that is supplied via the vehicle’s traction battery or energy storage device. Method 400 proceeds to 412.

At 412, method 400 closes electric grid electric isolation circuit 366 of FIG. 3 (e.g., closes transistors or contacts of electric grid electric isolation circuit 366) so that AC electric power that flows from stationary electric power grid 148 is isolated from electric machine 318. Thus, electric machine may not run from AC electric power that is supplied via the stationary electric power grid 148. Method 400 proceeds to 414.

At 414, method 400 may activate the electric machine 318, condenser fans, evaporator fans, controller 302, coolant pump 312, and coolant fan 310 in response to a temperature request or set point for temperature within the storage enclosure 206. In one example, the temperature request or set point for temperature within the storage enclosure 206 may be based on what energy source is providing power to cool the storage enclosure 206. For example, if the electric power is being provided via the stationary electric power grid 148, temperature within the storage enclosure may be controlled to -8 °C with + 2 °C temperature control range about the -5 °C set point. However, if the electric power is being provided via the vehicle’s electric energy storage device 132, temperature within the storage enclosure may be controlled to -3 °C with + 3 °C temperature control range about the -5 °C set point. The different set points and temperature control ranges may allow energy consumed by the portable temperature control system 204 to be controlled to reduce power consumption from the vehicle’s electric energy storage device as compared to when the AC electric power grid is providing power to the portable temperature control system 204. Consequently, the temperature control variation may be allowed to increase so that less electric power may be consumed by the portable temperature control system 204 when the portable temperature control system is electrically powered via the vehicle’s electric energy storage device.

Method 400 may adjust a speed of electric machine 318, condenser fan speeds, and evaporator fan speeds to adjust the rate of cooling within the portable storage enclosure and a temperature within the portable storage enclosure. Further, method 400 may adjust positions of an evaporator control valve and/or other valves to control temperature within the portable storage enclosure. If the portable temperature control system 204 is being electrically powered via electric power from the AC electric power grid, method 400 may deactivate inverter 306. Consequently, energy consumed via inverter 306 may be reduced. Likewise, method 400 may command the DC/DC converter 304 to be deactivated via CAN 190 if the portable temperature control system 204 is being electrically powered via electric power from the AC power grid.

Method 400 also controls coolant temperature and the temperature of inverter 306 and DC/DC converter 304 by adjusting a speed of coolant pump 312 and a speed of coolant fan 310. Method 400 proceeds to exit.

At 420, method 400 judges whether or not the portable storage unit and the portable storage unit temperature controller are electrically coupled to the electric energy storage device. In one example, if the portable temperature control system controller 302 detects high voltage DC at connector 356 shown in FIG. 3, the answer is yes and method 400 judges that the portable storage unit and the portable storage unit temperature controller are electrically coupled to the electric energy storage device 132 of FIG. 1. If the portable temperature control system controller 302 does not detect high voltage DC at connector 356 shown in FIG. 3, the answer is no and method 400 judges that the portable storage unit and the portable storage unit temperature controller are not electrically coupled to the electric energy storage device. If the answer is yes, method 400 proceeds to 422. Otherwise, method 400 proceeds to 430.

At 422, method 400 opens electric grid electric isolation circuit 366 of FIG. 3 (e.g., opens transistors or contacts of electric grid electric isolation circuit 366) so that AC electric power may not flow from stationary electric power grid 148 to electric machine 318. Thus, electric machine may not run from AC electric power that is supplied via the stationary electric power grid 148. Method 400 proceeds to 424.

At 424, method 400 closes inverter isolation circuit 342 of FIG. 3 (e.g., closes transistors or contacts of inverter isolation circuit 342) so that AC electric power that is generated from DC electric power is not isolated from electric machine 318. Thus, electric machine may run on power that is supplied via the vehicle’s traction battery or energy storage device. Method 400 proceeds to 414.

At 430, method 400 opens inverter isolation circuit 342 of FIG. 3 (e.g., opens transistors or contacts of inverter isolation circuit 342) so that AC electric power that is generated from DC electric power is isolated from electric machine 318. Thus, electric machine may not run from power that is supplied via the vehicle’s traction battery or energy storage device. Method 400 proceeds to exit.

At 432, method 400 opens electric grid electric isolation circuit 366 of FIG. 3 (e.g., opens transistors or contacts of electric grid electric isolation circuit 366) so that AC electric power may not flow from stationary electric power grid 148 to electric machine 318. Thus, electric machine may not run from AC electric power that is supplied via the stationary electric power grid 148. Method 400 proceeds to exit.

In this way, method 400 may automatically switch to AC power to operate the portable temperature control system 204 when the portable temperature control system 204 is coupled to stationary AC power grid. Further, method 400 may automatically switch to DC power to operate the portable temperature control system 204 when the portable temperature control system 204 is coupled to the vehicle’s DC power source and not electrically coupled to the AC power grid.

Thus, the method of FIG. 4 provides for a method for a portable temperature control system, comprising: automatically electrically coupling an electric machine to a stationary alternating current (AC) power grid in response to the stationary AC electric power grid being electrically coupled to the portable temperature control system; and automatically electrically coupling the electric machine to a vehicle’s direct current (DC) power source in response to the stationary AC electric power grid not being electrically coupled to the portable temperature control system and the vehicle’s DC electric power source being electrically coupled to the portable temperature control system. In a first example, the method for a portable temperature control system further comprises supplying DC electric power to at least an evaporator fan, at least a condenser fan, and at least a heat exchanger fan via the stationary AC electric power grid when the AC electric power grid is electrically coupled to the portable temperature control system. In a second example that may include the first example, the method for a portable temperature control system further comprises supplying DC electric power to at least an evaporator fan, at least a condenser fan, and at least a heat exchanger fan via the vehicle’s DC electric power source when the vehicle’s DC electric power source is electrically coupled to the portable temperature control system. In a third example that may include one or both of the first and second examples, the method for a portable temperature control system includes where the electric machine is automatically electrically coupled to the vehicle’s DC electric power source via a controller and an inverter isolation circuit, the inverter isolation circuit electrically coupling an inverter to the electric machine, and where the electric machine is mechanically coupled to a refrigerant compressor. In a fourth example that may include one or more of the first through third examples, the method for a portable temperature control system includes where the electric machine is automatically electrically coupled to the stationary AC electric power grid via an electric grid isolation circuit, the electric grid isolation circuit electrically coupling the stationary AC electric power grid to the electric machine, and where the electric machine is mechanically coupled to a refrigerant compressor. In a fifth example that may include one or more of the first through fourth examples, the method for a portable temperature control system further comprises adjusting a temperature within the portable temperature control system to a first temperature in response to the portable temperature control system being electrically coupled to the vehicle’s DC electric power source and adjusting the temperature within the portable temperature control system to a second temperature in response to the portable temperature control system being electrically coupled to the stationary AC electric power grid.

While various embodiments have been described above, it may be understood that they have been presented by way of example, and not limitation. It will be apparent to persons skilled in the relevant arts that the disclosed subject matter may be embodied in other specific forms without departing from the spirit of the subject matter. The embodiments described above are therefore to be considered in all respects as illustrative, not restrictive.

Note that the example control and estimation routines included herein can be used with various powertrain and/or vehicle system configurations. The control methods and routines disclosed herein may be stored as executable instructions in non-transitory memory and may be carried out by the control system including the controller in combination with the various sensors, actuators, and other transmission and/or vehicle hardware. Further, portions of the methods may be physical actions taken in the real world to change a state of a device. The specific routines described herein may represent one or more of any number of processing strategies such as event-driven, interrupt-driven, multi-tasking, multi-threading, and the like. As such, various actions, operations, and/or functions illustrated may be performed in the sequence illustrated, in parallel, or in some cases omitted. Likewise, the order of processing is not necessarily required to achieve the features and advantages of the example examples described herein, but is provided for ease of illustration and description. One or more of the illustrated actions, operations and/or functions may be repeatedly performed depending on the particular strategy being used. Further, the described actions, operations and/or functions may graphically represent code to be programmed into non-transitory memory of the computer readable storage medium in the vehicle and/or transmission control system, where the described actions are carried out by executing the instructions in a system including the various hardware components in combination with the electronic controller. One or more of the method steps described herein may be omitted if desired.

It will be appreciated that the configurations and routines disclosed herein are exemplary in nature, and that these specific examples are not to be considered in a limiting sense, because numerous variations are possible. For example, the above technology can be applied to powertrains that include different types of propulsion sources including different types of electric machines, internal combustion engines, and/or transmissions. The subject matter of the present disclosure includes all novel and non-obvious combinations and sub-combinations of the various systems and configurations, and other features, functions, and/or properties disclosed herein.

The following claims particularly point out certain combinations and sub-combinations regarded as novel and non-obvious. These claims may refer to “an” element or “a first” element or the equivalent thereof. Such claims may be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

As used herein, the terms “approximately” and “substantially” are construed to mean plus or minus five percent of the range, unless otherwise specified.

1. A portable temperature control system, comprising:
a direct current to direct current (DC/DC) electric power converter;
an alternating current to direct current (AC/DC) electric power converter;
an electric machine mechanically coupled to a refrigerant compressor; and
an inverter electrically coupled to the electric machine.

2. The portable temperature control system of claim 1, further comprising an electric vehicle, electric vehicle mechanically coupled to the portable temperature control system, the portable temperature control system not including a king pin to couple the portable temperature control system to the electric vehicle.

3. The portable temperature control system of claim 1, further comprising an electric vehicle, electric vehicle mechanically coupled to the portable temperature control system, the portable temperature control system including a king pin to couple the portable temperature control system to the electric vehicle.

4. The portable temperature control system of claim 1, further comprising a power distribution unit, the DC/DC electric power converter and the AC/DC electric power converter electrically coupled to the power distribution unit.

5. The portable temperature control system of claim 4, further comprising at least one condenser fan, at least one evaporator fan, the power distribution unit electrically coupled to the at least one condenser fan and the at least one evaporator fan.

6. The portable temperature control system of claim 5, further comprising a coolant pump and a heat exchanger, the coolant pump and the heat exchanger fluidically coupled to the DC/DC electric power converter.

7. The portable temperature control system of claim 6, where the inverter is fluidically coupled to the coolant pump and the heat exchanger.

8. The portable temperature control system of claim 7, further comprising a heat exchanger fan, the heat exchanger fan electrically coupled to the power distribution unit.

9. The portable temperature control system of claim 1, further comprising a controller, the controller configured to automatically provide electric power to the electric machine solely via a stationary AC electric power grid when the stationary AC electric power grid is coupled to the portable temperature control system, the controller configured to automatically provide electric power to the electric machine solely via a vehicle’s DC electric power source when the stationary AC electric power grid is decoupled from the portable temperature control system and when the vehicle’s DC electric power source is electrically coupled to the portable temperature control system.

10. A method for a portable temperature control system, comprising:
automatically electrically coupling an electric machine to a stationary alternating current (AC) power grid in response to the stationary AC electric power grid being electrically coupled to the portable temperature control system; and
automatically electrically coupling the electric machine to a vehicle’s direct current (DC) electric power source in response to the stationary AC electric power grid not being electrically coupled to the portable temperature control system and the vehicle’s DC electric power source being electrically coupled to the portable temperature control system.

11. The method for the portable temperature control system of claim 10, further comprising supplying DC electric power to at least an evaporator fan, at least a condenser fan, and at least a heat exchanger fan via the stationary AC electric power grid when the stationary AC electric power grid is electrically coupled to the portable temperature control system.

12. The method for the portable temperature control system of claim 10, further comprising supplying DC electric power to at least an evaporator fan, at least a condenser fan, and at least a heat exchanger fan via the vehicle’s DC electric power source when the vehicle’s DC electric power source is electrically coupled to the portable temperature control system.

13. The method for the portable temperature control system of claim 10, where the electric machine is automatically electrically coupled to the vehicle’s DC electric power source via a controller and an inverter isolation circuit, the inverter isolation circuit electrically coupling an inverter to the electric machine, and where the electric machine is mechanically coupled to a refrigerant compressor.

14. The method for the portable temperature control system of claim 10, where the electric machine is automatically electrically coupled to the stationary AC electric power grid via an electric grid isolation circuit, the electric grid isolation circuit electrically coupling the stationary AC electric power grid to the electric machine, and where the electric machine is mechanically coupled to a refrigerant compressor.

15. The method for the portable temperature control system of claim 10, further comprising adjusting a temperature within the portable temperature control system to a first temperature in response to the portable temperature control system being electrically coupled to the vehicle’s DC electric power source and adjusting the temperature within the portable temperature control system to a second temperature in response to the portable temperature control system being electrically coupled to the stationary AC electric power grid.

16. A portable temperature control system, comprising:
a direct current to direct current (DC/DC) electric power converter;
an alternating current to direct current (AC/DC) electric power converter;
an electric machine mechanically coupled to a refrigerant compressor;
an inverter;
an inverter isolation circuit;
an electric grid isolation circuit; and
a controller configured to automatically close the electric grid isolation circuit to provide electric power to the electric machine via a stationary electric grid and electrically isolate output of the inverter from the electric machine in response to the stationary electric grid being electrically coupled to the portable temperature control system.

17. The portable temperature control system of claim 16, where the controller is further configured to automatically close the inverter isolation circuit to provide electric power to the electric machine via the inverter and electrically isolate output of the stationary electric grid from the electric machine in response to the stationary electric grid being electrically decoupled from the portable temperature control system and a vehicle DC electric power source being electrically coupled to the portable temperature control system.

18. The portable temperature control system of claim 16, where the controller includes executable instructions that cause the controller to adjust cooling of the portable temperature control system according to which of a vehicle DC electric power source and the stationary electric grid are providing power to the electric machine.

19. The portable temperature control system of claim 16, where the controller includes executable instructions that cause the controller to adjust cooling of the portable temperature control system via adjusting a rotational speed of the electric machine, evaporator fan speed, and condenser fan speed.

20. The portable temperature control system of claim 16, where the electric grid isolation circuit is comprised of a first group of switches and where the stationary electric grid is comprised of a second group of switches.
